(19) United States
(12) Patent Application Publication
(10) Pub. No.: US 2025/0190800 A1
(43) Pub. Date: Jun. 12, 2025

(54) METHOD AND APPARATUS FOR TRAINING DEEP LEARNING MODEL TO SEARCH OPTIMAL ARCHITECTURE OF NEURAL NETWORK FOR KNOWLEDGE DISTILLATION

(71) Applicant: Korea Advanced Institute of Science and Technology, Daejeon (KR)

(72) Inventors: Sung Ju HWANG, Daejeon (KR); Ha Yeon LEE, Daejeon (KR); So Hyun AN, Daejeon (KR); Min Seon KIM, Daejeon (KR)

(21) Appl. No.: 18/389,856

(22) Filed: Dec. 20, 2023

(30) Foreign Application Priority Data
Dec. 7, 2023 (KR) 10-2023-0176940

(51) Int. Cl. G06N 3/084; G06N 3/04

(52) U.S. Cl. CPC G06N 3/084; G06N 3/04

(57) ABSTRACT

The present disclosure relates to a method for training a deep learning model to search for an optimal architecture of a neural network for knowledge distillation. An information about a metadata set related to a first domain is obtained. An information about at least one candidate architecture of a neural network included in a search space using the information about the metadata set is obtained. A performance evaluation information about the at least one candidate architecture is output by inputting the information about the metadata set and the information about the at least one candidate architecture into the deep learning model. The deep learning model is trained through backpropagation to minimize a loss function that is determined on the basis of the performance evaluation information and label information included in the information about the metadata set.

### TECHNICAL FIELD

The present disclosure relates to a method and apparatus for training a deep learning model to search for an optimal architecture of a neural network for knowledge distillation.

The study relates to a project (No. 0422002600, Meta-learning applicable to real-world problems) conducted under the funds and the support of KAIST.

### BACKGROUND

Recently, various tasks that could not be solved with past technologies could be successfully performed with the development of deep learning.

However, deep learning models that show state-of-the-art performance in various fields including image classification have a limitation in that most of them are results manually designed by experts in corresponding fields.

That is, according to the related art, when a task and a dataset are given, a designer searches for the structure of an optimal deep learning model while evaluating the performance of deep learning models that are determined by manually setting components such as the number of layers, the number of filters, and the size of filters, and there is a defect in that it is very costly and takes a lot of time to search the structure of an optimal deep learning model.

Further, it is difficult to consider that a deep learning model derived in this way has good performance for other tasks and other datasets.

Accordingly, it is required to develop a technology of automating the process of designing a deep learning model and quickly searching for a neural architecture optimized for a given task.

### SUMMARY

In accordance with one aspect of the present disclosure, there is provided a method of training a deep learning model to search for an optimal architecture of a neural network for knowledge distillation, the method comprising: obtaining information about a metadata set related to a first domain; obtaining information about at least one candidate architecture of a neural network included in a search space using the information about the metadata set;

outputting performance evaluation information about the at least one candidate architecture by inputting the information about the metadata set and the information about the at least one candidate architecture into the deep learning model; and training the deep learning model through backpropagation to minimize a loss function that is determined on the basis of the performance evaluation information and label information included in the information about the metadata set.

Preferably, the information about the metadata set has a first training dataset corresponding to a predetermined task related to the first domain, information about a first teacher model pre-trained on the basis of the first training dataset, and first label information about the first training dataset.

Preferably, in the obtaining of information about at least one candidate architecture of a neural network, the at least one candidate architecture of the neural network is determined through random sampling from all of the available candidate architectures of the neural network included in the search space.

Preferably, the obtaining of information about at least one candidate architecture includes updating parameters for the at least one candidate architecture by remapping parameters for the pre-trained first teacher model to the at least one candidate architecture.

Preferably, the outputting of performance evaluation information about the at least one candidate architecture includes outputting knowledge distillation accuracy (KD accuracy) for the at least one candidate architecture whose parameters have been updated using the deep learning model.

Preferably, the training of the deep learning model includes training the deep learning mode to minimize a difference between knowledge distillation accuracy for at least one candidate architecture that is output using the deep learning model and prediction accuracy for the at least one candidate architecture included in the first label information.

In accordance with another aspect of the present disclosure, there is provided a non-transitory computer-readable storage medium storing a computer program, the computer program including instructions causing a processor to perform, when executed by the processor, a method of training a deep learning model to search for an optimal architecture of a neural network for knowledge distillation, the method comprising: obtaining information about a metadata set related to a first domain; obtaining information about at least one candidate architecture of a neural network included in a search space using the information about the metadata set; outputting performance evaluation information about the at least one candidate architecture by inputting the information about the metadata set and the information about the at least one candidate architecture into the deep learning model; and training the deep learning model through backpropagation to minimize a loss function that is determined on the basis of the performance evaluation information and label information included in the information about the metadata set.

Preferably, the information about the metadata set has a first training dataset corresponding to a predetermined task related to the first domain, information about a first teacher model pre-trained on the basis of the first training dataset, and first label information about the first training dataset.

Preferably, in the obtaining of information about at least one candidate architecture of a neural network, the at least one candidate architecture of the neural network is determined through random sampling from all of the available candidate architectures of the neural network included in the search space.

Preferably, the obtaining of information about at least one candidate architecture includes updating parameters for the at least one candidate architecture by remapping parameters for the pre-trained first teacher model to the at least one candidate architecture.

Preferably, the outputting of performance evaluation information about the at least one candidate architecture includes outputting knowledge distillation accuracy (KD accuracy) for the at least one candidate architecture whose parameters have been updated using the deep learning model.

Preferably, the training of the deep learning model includes training the deep learning mode to minimize a difference between knowledge distillation accuracy for at least one candidate architecture that is output using the deep learning model and prediction accuracy for the at least one candidate architecture included in the first label information.

In accordance with a still another aspect of the present disclosure, there is provided an apparatus for searching for an optimal architecture of a neural network for knowledge distillation, the apparatus comprising: a memory in which a neural network model search program is stored; and a processor configured to load the neural network model search program from the memory and to execute the neural network model search program, wherein the processor configured to: input a second dataset related to a second domain and information about a second teacher model pre-trained about the second dataset into a deep learning model, and determine an architecture corresponding to a student model, to which knowledge of the second teacher model will be distilled, of at least one candidate architecture of a neural network included in a search space on the basis of performance evaluation information that is output by the pre-trained deep learning model, and wherein the pre-trained deep learning model has been trained on the basis of a first training dataset related to a first domain and information about a first teacher model pre-trained on the basis of the first training dataset.

Preferably, the second dataset related to the second domain is unrelated to the first training dataset related to the first domain.

Preferably, the processor determines a candidate architecture of which knowledge distillation accuracy included in the performance evaluation information is the highest of the at least one candidate architecture of the neural network included in the search space, as an architecture corresponding to the student model.

According to an embodiment of the present disclosure, it is possible to achieve effects of not only being able to increase a rate of learning for a new task, but also being able to effectively train a deep learning model even with a small amount of data by meta-training on the deep learning model using knowledge distillation.

Further, according to an embodiment of the present disclosure, it is possible to achieve an effect of being able to reduce the time and cost that are taken to search a neural network model because it is possible to search an optimal neural network model using knowledge extracted through knowledge distillation.

### BRIEF DESCRIPTION OF THE DRAWINGS

FIG. 1 is a block diagram showing an apparatus for training a deep learning model according to an embodiment of the present disclosure.

FIG. 2 is a block diagram conceptually showing the function of a deep learning model training program according to an embodiment of the present disclosure.

FIG. 3 is a flowchart showing a method of training a deep learning model according to an embodiment of the present disclosure.

FIG. 4 is a block diagram conceptually showing the function of a neural network model search program according to an embodiment of the present disclosure.

FIG. 5 is a flowchart showing a method of searching a neural network model according to an embodiment of the present disclosure.

FIG. 6 is a diagram exemplarily showing a method of training a deep learning model and a method of searching a neural network model using a deep learning model according to an embodiment of the present disclosure.

### DETAILED DESCRIPTION

The advantages and features of embodiments and methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

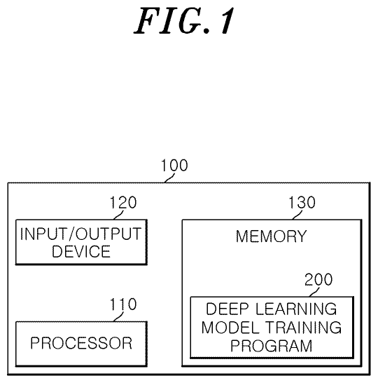

FIG. 1 is a block diagram showing an apparatus for training a deep learning model according to an embodiment of the present disclosure.

Referring to FIG. 1, an apparatus 100 for training a deep learning model may include a processor 110, an input/output device 120, and a memory 130.

The processor 110 can generally control operation of the apparatus 100 for training a deep learning model.

The processor 110 can receive information about a metadata set related to a predetermined domain using the input/output device 120. Further, the processor 110 can receive information about a candidate architecture of a neural network included in a search space using the input/output device 120.

In the present disclosure, a predetermined domain may mean a task domain showing the type of a task (e.g., image classification, natural language processing, robot control, etc.) according to the type of data (e.g., text data, image data, etc.).

Further, in the present disclosure, information about a dataset may mean information for meta-training of a deep learning model. In this case, the meta-training is a training method enabling a model to quickly adapt itself to a new task or generalize a new task, and it is possible to increase the rate of learning for a new task and achieve effective learning even with a small amount of data through meta-training.

Further, in the present disclosure, a search space may mean a set of all of the available candidate architectures showing the structure or configuration of a deep learning model. For example, a search space may include components, such as the number of layers, the kind of each layer, parameters of each layer, learning efficiency, the width of a channel, the size of an array, and a connection type, in the form of a one-hot vector.

In the present disclosure, it was described that information about a metadata set related to a predetermined domain and information about a candidate architecture of a neural network included in a search space are input through the input/output device 120, but the present disclosure is not limited thereto. That is, depending on embodiments, the deep learning model training device 100 may include a transceiver (not shown), the deep learning model training device 100 may receive at least one of information about a metadata set related to a predetermined domain and information about a candidate architecture of a neural network included in a search space using the transceiver (not shown), and at least one of the information about a metadata set related to a predetermined domain and the information about a candidate architecture of a neural network included in a search space may be created in the deep learning model training device 100.

In this case, the information about a metadata set related to a predetermined domain according to an embodiment of the present disclosure may include information about a teacher model pre-trained on the basis of a training dataset and training data.

Further, the information about a candidate architecture of a neural network according to an embodiment of the present disclosure may mean information about an architecture of a neural network that can be defined by combining components in a search space.

The processor 110 can obtain information about a metadata set related to a first domain, obtain information about at least one candidate architecture of a neural network included in a search space using the information about a metadata set, output performance evaluation information about the at least one architecture by inputting the information about a metadata set and the information about at least one candidate architecture into a deep learning model, and train the deep learning model through backpropagation to minimize a loss function that is determined on the basis of the performance evaluation information and label information included in the information about the metadata set.

The input/output device 120 may include one or more input devices and/or one or more output devices. For example, the input device may include a microphone, a keyboard, a mouse, a touch screen, etc. and the output device may include a display, a speaker, etc.

The memory 130 can store a deep learning model training program 200 and information for executing the deep learning model training program 200.

In the specification, the deep learning model training program 200 may mean software that receives information about a metadata set related to a predetermined domain and includes commands for training a deep learning model using knowledge distillation for a metadata set.

The processor 110 can load the deep learning model training program 200 and the information for executing the deep learning model training program 200 from a memory 130 to execute the deep learning model training program 200.

The processor 110 can train a deep learning model to receive information about a metadata set related to a predetermined domain and information about at least one candidate architecture and output performance evaluation information about the at least one candidate architecture by executing the deep learning model training program 200.

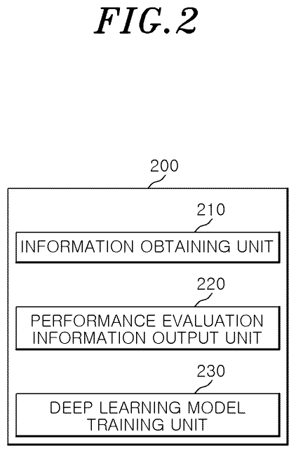

The function and/or operation of the deep learning model training program 200 are described in detail with reference to FIG. 2.

FIG. 2 is a block diagram conceptually showing the function of a deep learning model training program according to an embodiment of the present disclosure.

Referring to FIG. 2, the deep learning model training program 200 may include an information obtaining unit 210, a performance evaluation information output unit 220, and a deep learning model training unit 230.

The information obtaining unit 210, the performance evaluation information output unit 220, and the deep learning model training unit 230 shown in FIG. 2 are defined to conceptually divide the function of the deep learning model training program 200 in order to easily describe the function of the deep learning model training program 200, and the present disclosure is not limited thereto. Depending on embodiments, the functions of the information obtaining unit 210, the performance evaluation information output unit 220, and the deep learning model training unit 230 can be combined/separated and may be implemented by a series of commands included in one program.

First, the information obtaining unit 210 can obtain information about a metadata set related to a first domain.

In detail, information about a metadata set according to an embodiment of the present disclosure may include a first training dataset corresponding to a predetermined task related to a first domain, information about a first teacher model pre-trained on the basis of the first training dataset, and first label information about the first training dataset.

In this case, the information about a first teacher model according to an embodiment of the present disclosure may include prediction accuracy that is output by inputting the first training dataset into the first teacher model.

Further, the first label information about the first training dataset according to an embodiment of the present disclosure may include prediction accuracy that is output by inputting the first training dataset into all of the available candidate architectures of a neural network included in a search space.

Further, the information obtaining unit 210 can obtain information about at least one candidate architecture of a neural network included in a search space using information about a metadata set.

In this case, the at least one candidate architecture of a neural network may be determined through random sampling (or random search) from all of the available candidate architectures of a neural network included in a search space.

In detail, the information obtaining unit 210 can update parameters for at least one candidate architecture by remapping parameters for the pre-trained first teacher model to the at least one candidate architecture.

In more detail, the information obtaining unit 210 can obtain information about at least one candidate architecture randomly determined or initialized in a search space by updating parameters for the at least one candidate architecture to parameters for the pre-trained first teacher model.

The information about at least one candidate architecture according to an embodiment of the present disclosure may include information (e.g., the number of layers, the width of a channel, etc.) about the structure of the at least one candidate architecture whose parameters have been updated.

Further, the information about at least one candidate architecture may include information about a feature map that is output by inputting a certain dataset (e.g., a preset Gaussian random tensor) to the at least one candidate architecture whose parameters have been updated. That is, the information about the feature map may show the performance of a candidate architecture knowledge-distilled from a teacher model regardless of a task corresponding to a training dataset.

Next, the performance evaluation information output unit 220 can output performance evaluation information about at least one candidate architecture by inputting information about a metadata set and information about the at least one candidate architecture into a deep learning model. In this case, the performance evaluation information may mean information showing prediction accuracy of a knowledge-distilled at least one candidate architecture.

In detail, the performance evaluation information output unit 220 can output knowledge distillation accuracy (KD accuracy) for at least one candidate architecture whose parameters have been updated using a deep learning model.

In more detail, the performance evaluation information output unit 220 can output knowledge distillation accuracy, which is prediction accuracy that is output by inputting a first training dataset to at least one candidate architecture knowledge-distilled from a first teacher model.

Next, the deep learning model training unit 230 can train a deep learning model through backpropagation to minimize a loss function that is determined on the basis of performance evaluation information and label information included in information about a metadata set.

In detail, the deep learning model training unit 230 can train a deep learning model to minimize the difference between knowledge distillation accuracy for at least one candidate architecture that is output using the deep learning model and prediction accuracy for the at least one candidate architecture included in first label information.

Meanwhile, the deep learning model training unit 230 can meta-train a deep learning model using a plurality of datasets included in a first domain, information about each of a plurality of teacher models pre-trained on the basis of the plurality of datasets, respectively, and a plurality of items of label information respectively for the plurality of datasets.

Accordingly, it is possible to achieve effects of not only being able to increase a rate of learning for a new task, but also being able to effectively train a deep learning model even with a small amount of data by meta-training the deep learning model using knowledge distillation.

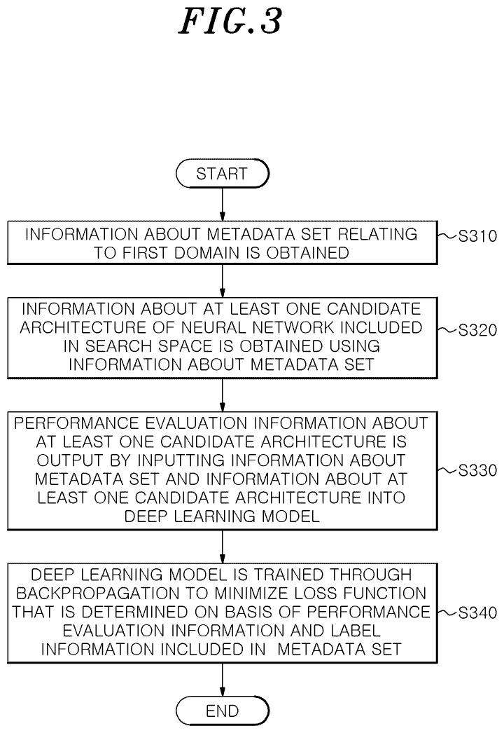

FIG. 3 is a flowchart showing a method of training a deep learning model according to an embodiment of the present disclosure.

Referring to FIG. 2 and FIG. 3, the information obtaining unit 210 can obtain information about a metadata set related to a first domain (S310).

Further, the information obtaining unit 210 can obtain information about at least one candidate architecture of a neural network included in a search space using the information about the metadata set (S320).

Next, the performance evaluation information output unit 220 can output performance evaluation information about the at least one candidate architecture by inputting the information about the metadata set and the information about the at least one candidate architecture into the deep learning model (S330).

Next, the deep learning model training unit 230 can train the deep learning model through backpropagation to minimize a loss function that is determined on the basis of the performance evaluation information and label information included in the metadata set (S340).

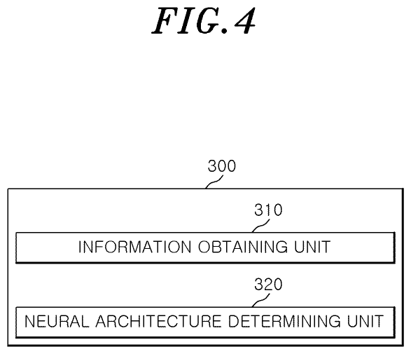

FIG. 4 is a block diagram conceptually showing the function of a neural network model search program according to an embodiment of the present disclosure.

A neural network model search program 300 according to an embodiment of the present disclosure may be executed in a neural network model search device (not shown) for knowledge distillation and the neural network model search device may include a processor (not shown) and a memory (not shown).

The processor (not shown) can generally control operation of the neural network model search device (not shown).

The processor (not shown) can determine an architecture corresponding to a student model, to which the knowledge of a second teacher model will be distilled, by inputting a second dataset related to a second domain and information about the second teacher model pre-trained about the second dataset to a pre-trained deep learning model.

In this case, the pre-trained deep learning model may have been trained on the basis of a first training dataset related to a first domain and information about a first teacher model pre-trained on the basis of the first training dataset.

The memory (not shown) can store a neural network model search program 300 and information for executing the neural network model search program 300.

In the specification, the neural network model search program 300 may mean software that obtains a second dataset related to a second domain and information about a second teacher model pre-trained about the second dataset and includes commands for determining an architecture corresponding to a student model, to which knowledge of the second teacher model will be distilled, of at least one candidate architecture of a neural network included in a search space by inputting the second dataset related to the second domain and the information about the second teacher model pre-trained about the second dataset into a pre-trained deep learning model.

The processor (not shown) can load the neural network model search program 300 and information for executing the neural network model search program 300 from the memory (not shown) to execute the neural network model search program 300.

The processor (not shown) can search for an optimal architecture for knowledge distillation by executing the neural network model search program 300.

The function and/or operation of the neural network model search program 300 are described in detail with reference to FIG. 4.

An information obtaining unit 310 and a neural architecture determining unit 320 shown in FIG. 4 were defined to conceptually divide the function of the neural network model search program 300 in order to easily describe the function of the neural network model search program 300, but the present disclosure is not limited thereto. Depending on embodiments, the functions of the information obtaining unit 310 and the neural architecture determining unit 320 can be combined/separated and may be implemented by a series of commands included in one program.

First, the information obtaining unit 310 can obtain a second dataset related to a second domain and information about a second teacher model pre-trained about the second dataset.

In this case, the information about the second teacher model according to an embodiment of the present disclosure may include prediction accuracy that is output by inputting the second dataset into the second teacher model.

Meanwhile, the second dataset related to the second domain may not relate to the first training dataset related to the first domain. This may mean that the first domain and the second domain show different task domains and the second dataset was not used in pre-training of the deep learning model.

First, the information obtaining unit 310 can input the second dataset related to the second domain and the information about the second teacher model pre-trained about the second dataset into the pre-trained deep learning model.

Next, the neural architecture determining unit 320 can determine an architecture corresponding to a student model, to which knowledge of the second teacher model will be distilled, of at least one candidate architecture of a neural network included in a search space on the basis of performance evaluation information that is output by the pre-trained deep learning model.

In detail, the neural architecture determining unit 320 can determine a candidate architecture of which the knowledge distillation accuracy included in performance evaluation information is the highest of at least one candidate architecture of a neural network included in a search space, as an architecture corresponding to a student model.

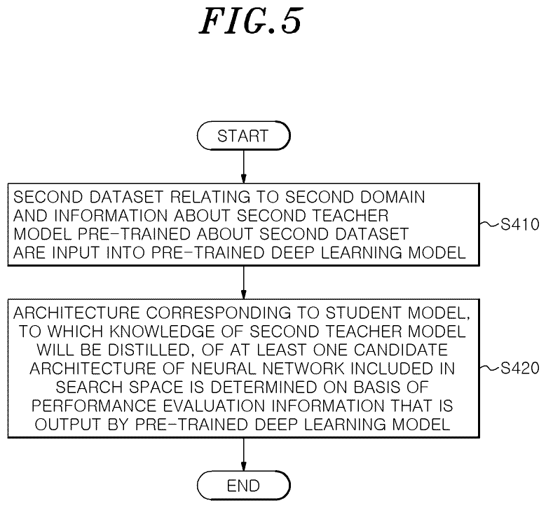

FIG. 5 is a flowchart showing a method of searching a neural network model according to an embodiment of the present disclosure.

Referring to FIG. 4 and FIG. 5, the information obtaining unit 310 can input a second dataset related to a second domain and information about a second teacher model pre-trained about the second dataset into a pre-trained deep learning model (S410).

Next, the neural architecture determining unit 320 can determine an architecture corresponding to a student model, to which knowledge of the second teacher model will be distilled, of at least one candidate architecture of a neural network included in a search space on the basis of performance evaluation information that is output by the pre-trained deep learning model (S420).

In this case, the pre-trained deep learning model may have been trained on the basis of a first training dataset related to a first domain and information about a first teacher model pre-trained on the basis of the first training dataset.

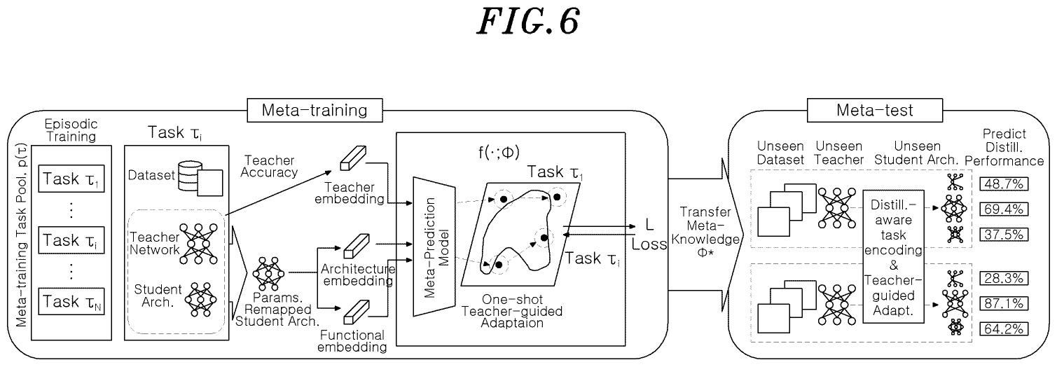

FIG. 6 is a diagram exemplarily showing a method of training a deep learning model and a method of searching a neural network model using a deep learning model according to an embodiment of the present disclosure.

In detail, a deep learning model may mean a meta-prediction model and FIG. 6 may show searching for an optimal neural architecture by meta-training a meta-prediction model and performing a meta-test using the trained meta-prediction model.

First, referring to FIG. 2 and FIG. 6 in relation to a meta-prediction model, the information obtaining unit 210 can obtain information about a metadata set corresponding to a predetermined task τᵢ related to a first domain. The information about the metadata set may include a first training dataset, information about a first teacher model pre-trained on the basis of the first training dataset, and first label information about the first training metadata set.

In detail, the information obtaining unit 210 can obtain a teacher embedding vector by mapping the information about the pre-trained first teacher model to a lower-dimensional space by passing the information through a nonlinear projection layer.

Further, the information obtaining unit 210 can obtain information about at least one candidate architecture of a neural network included in a search space using the information about the metadata set. The information about the at least one candidate architecture may include information about the structure of the at least one candidate architecture whose parameters have been updated and information about a feature map that is output by inputting a certain dataset (e.g., a preset Gaussian random tensor) to the at least one candidate architecture whose parameters have been updated.

In detail, the information obtaining unit 210 can obtain an architecture embedding vector and a functional embedding vector by mapping the information about the structure of the at least one candidate architecture and the information about the feature map to a lower-dimensional space by passing the items of information through the nonlinear projection layer.

Next, the performance evaluation information output unit 220 can output performance evaluation information about the at least one candidate architecture by inputting the information about the metadata set and the information about the at least one candidate architecture into the meta-prediction model.

In detail, the performance evaluation information output unit 220 can output knowledge distillation accuracy for the at least one candidate architecture whose parameters have been updated by inputting the teacher embedding vector, the architecture embedding vector, and the functional embedding vector into the meta-prediction model.

Next, the deep learning model training unit 230 can train a deep learning model through backpropagation to minimize a loss function that is determined on the basis of performance evaluation information and label information included in information about a metadata set, and the loss function may mean a function about a mean squared error.

In detail, the deep learning model training unit 230 can train a meta-prediction model to minimize the difference between knowledge distillation accuracy for at least one candidate architecture that is output using the meta-prediction model and prediction accuracy for the at least one candidate architecture included in first label information.

Further, the deep learning model training unit 230 can train a meta-prediction model to minimize a loss function that is determined using a plurality of datasets included in a first domain, information about each of a plurality of teacher models pre-trained on the basis of the plurality of datasets, respectively, and a plurality of items of label information respectively for the plurality of datasets, which can be expressed as the following Formula 1.

$$min ( ∅ ) {\sum }_{τ ∼ p ( τ )} L ( f ( S , {t}^{τ} ( \cdot ; {D}^{τ} , {\tilde{θ}}^{{}_{{}_{τ}}} ) ; ∅ ) , {Y}^{τ} ) \qquad [ Formula 1 ]$$

Here, L may mean a loss function about a mean square error, τ may mean a predetermined task, f(S,t^{τ}(.;D^{τ}, \tilde{θ}^{τ}))may mean performance evaluation information of a meta-prediction model, Y^{τ} may mean label information, and Ø may mean a parameter of the meta-prediction model. S may mean information about at least one candidate architecture, t^{τ} may mean a teacher model, D^{τ} may mean a training dataset, and \tilde{θ}^{τ} may mean a parameter of a teacher model pre-trained on the basis of the training dataset.

As described above, parameters of a meta-prediction model can be updated using knowledge distillation for a teacher model and the meta-prediction model can be trained about task distribution.

Next, referring to FIG. 4 and FIG. 6 in relation to searching for an optimal neural architecture accompanying a meta test, the information obtaining unit 310 can obtain a second dataset related to a second domain and information about a second teacher model pre-trained about the second dataset.

In detail, the information obtaining unit 310 can input the second dataset (i.e., an unseen dataset) and the information about the second teacher model (i.e., an unseen teacher) to a meta-prediction model.

In this case, the second dataset related to the second domain is unrelated to the first training dataset related to the first domain.

Further, the neural architecture determining unit 320 can determine an architecture corresponding to a student model, to which knowledge of the second teacher model will be distilled, of at least one candidate architecture of a neural network included in a search space on the basis of performance evaluation information that is output by the pre-trained deep learning model.

In detail, the neural architecture determining unit 320 can output knowledge distillation accuracy for at least one candidate architecture of a neural network included in a search space using a pre-trained meta-prediction model and can determine a candidate architecture having the highest knowledge distillation accuracy as an architecture corresponding to a student model (i.e., as a neural architecture having knowledge distillation accuracy of 69.4% and a neural architecture having knowledge distillation accuracy of 87.1%).

Accordingly, it is possible to search an optimal neural network model, so it is possible to achieve the effect of reducing the time and costs that are taken to search for a neural network model.

Combinations of each block of the block diagrams and each step of the flowchart attached to the present disclosure may be performed by computer program instructions. Since these computer program instructions can be installed in an encoding processor of a general-purpose computer, a special-purpose computer, or other programmable data processing equipment, the instructions executed through the encoding processor of the computer or other programmable data processing equipment generate means for executing functions described in each block of the block diagrams or each step of the flowchart. These computer program instructions may also be stored in a computer-usable or computer-readable memory that can be directed to computers or other programmable data processing equipment to implement functions in a particular way, and thus the instructions stored in the computer-usable or computer-readable memory can also produce manufactured items containing instruction means for executing the functions described in each block of the block diagram or each step of the flowchart. Since the computer program instructions can also be installed in a computer or other programmable data processing equipment, a series of operational steps may be performed on the computer or other programmable data processing equipment to create a process that is executed by the computer, thereby providing steps for executing the functions described in each block of the block diagrams and each step of the flowchart through the instructions.

Additionally, each block or each step may represent a module, a segment, or some code that includes one or more executable instructions for executing specified logical function(s). Additionally, it should be noted that, in some alternative embodiments, the functions mentioned in blocks or steps are executed out of order. For example, two blocks or steps shown in succession may be performed substantially simultaneously, or the blocks or steps may sometimes be performed in reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method of training a deep learning model to search for an optimal architecture of a neural network for knowledge distillation, the method comprising:
obtaining information about a metadata set related to a first domain;
obtaining information about at least one candidate architecture of a neural network included in a search space using the information about the metadata set;
outputting performance evaluation information about the at least one candidate architecture by inputting the information about the metadata set and the information about the at least one candidate architecture into the deep learning model; and
training the deep learning model through backpropagation to minimize a loss function that is determined on the basis of the performance evaluation information and label information included in the information about the metadata set.

2. The method of claim 1, wherein the information about the metadata set has a first training dataset corresponding to a predetermined task related to the first domain, information about a first teacher model pre-trained on the basis of the first training dataset, and first label information about the first training dataset.

3. The method of claim 1, wherein, in the obtaining of information about at least one candidate architecture of a neural network, the at least one candidate architecture of the neural network is determined through random sampling from all of the available candidate architectures of the neural network included in the search space.

4. The method of claim 2, wherein the obtaining of information about at least one candidate architecture includes updating parameters for the at least one candidate architecture by remapping parameters for the pre-trained first teacher model to the at least one candidate architecture.

5. The method of claim 4, wherein the outputting of performance evaluation information about the at least one candidate architecture includes outputting knowledge distillation accuracy (KD accuracy) for the at least one candidate architecture whose parameters have been updated using the deep learning model.

6. The method of claim 5, wherein the training of the deep learning model includes training the deep learning mode to minimize a difference between knowledge distillation accuracy for at least one candidate architecture that is output using the deep learning model and prediction accuracy for the at least one candidate architecture included in the first label information.

7. An apparatus for searching for an optimal architecture of a neural network for knowledge distillation, the apparatus comprising:
a memory in which a neural network model search program is stored; and
a processor configured to load the neural network model search program from the memory and to execute the neural network model search program,
wherein the processor configured to:
input a second dataset related to a second domain and information about a second teacher model pre-trained about the second dataset into a deep learning model, and
determine an architecture corresponding to a student model, to which knowledge of the second teacher model will be distilled, of at least one candidate architecture of a neural network included in a search space on the basis of performance evaluation information that is output by the pre-trained deep learning model, and
wherein the pre-trained deep learning model has been trained on the basis of a first training dataset related to a first domain and information about a first teacher model pre-trained on the basis of the first training dataset.

8. The apparatus of claim 7, wherein the second dataset related to the second domain is unrelated to the first training dataset related to the first domain.

9. The apparatus of claim 7, wherein the processor determines a candidate architecture of which knowledge distillation accuracy included in the performance evaluation information is the highest of the at least one candidate architecture of the neural network included in the search space, as an architecture corresponding to the student model.

10. A non-transitory computer-readable recording medium storing a computer program, the computer program including instructions causing a processor to perform, when executed by the processor, a method of training a deep learning model to search for an optimal architecture of a neural network for knowledge distillation, the method comprising:
obtaining information about a metadata set related to a first domain;
obtaining information about at least one candidate architecture of a neural network included in a search space using the information about the metadata set;
outputting performance evaluation information about the at least one candidate architecture by inputting the information about the metadata set and the information about the at least one candidate architecture into the deep learning model; and
training the deep learning model through backpropagation to minimize a loss function that is determined on the basis of the performance evaluation information and label information included in the information about the metadata set.

11. The computer-readable recording medium of claim 10, wherein the information about the metadata set has a first training dataset corresponding to a predetermined task related to the first domain, information about a first teacher model pre-trained on the basis of the first training dataset, and first label information about the first training dataset.

12. The computer-readable recording medium of claim 10, wherein, in the obtaining of information about at least one candidate architecture of a neural network, the at least one candidate architecture of the neural network is determined through random sampling from all of the available candidate architectures of the neural network included in the search space.

13. The computer-readable recording medium of claim 11, wherein the obtaining of information about at least one candidate architecture includes updating parameters for the at least one candidate architecture by remapping parameters for the pre-trained first teacher model to the at least one candidate architecture.

14. The computer-readable recording medium of claim 13, wherein the outputting of performance evaluation information about the at least one candidate architecture includes outputting knowledge distillation accuracy (KD accuracy) for the at least one candidate architecture whose parameters have been updated using the deep learning model.

15. The computer-readable recording medium of claim 14, wherein the training of the deep learning model includes training the deep learning mode to minimize a difference between knowledge distillation accuracy for at least one candidate architecture that is output using the deep learning model and prediction accuracy for the at least one candidate architecture included in the first label information.
